(19) United States
(12) Patent Application Publication
(10) Pub. No.: US 2026/0147337 A1
(43) Pub. Date: May 28, 2026

(54) METHOD FOR DETECTING ABNORMALITIES IN EQUIPMENT AND ELECTRONIC DEVICE

(71) Applicant: Fullian Precision Electronics (Tianjin) Co, LTD., Tianjin (CN)

(72) Inventor: CHENG-YU WANG, New Taipei (TW)

(21) Appl. No.: 19/004,716

(22) Filed: Dec. 30, 2024

(30) Foreign Application Priority Data
Nov. 26, 2024 (CN) 202411706662.0

(51) Int. Cl. G05B 23/02

(52) U.S. Cl. CPC G05B 23/024; G05B 23/027; G05B 23/0275

(57) ABSTRACT

The present application provides a method for detecting abnormalities in equipment and an electronic device. The method includes: obtaining correlation weights by performing a correlation analysis on performance indicator data; determining a time attenuation weight of the abnormal event; based on the correlation weights and the time attenuation weight, obtaining an attention weight of the performance indicator data by performing a self-attention analysis on the performance indicator data and historical indicator data of the abnormal event using a self-attention mechanism; determining a convergence indicator of an expert model according to performance evaluation data of the expert model corresponding to the performance indicator data; in response that the expert model is determined to be qualified, obtaining an abnormal detection result of the equipment under test by using the expert model according to a time domain feature, a frequency domain feature and normalized performance indicator data.

### CROSS-REFERENCE TO RELATED APPLICATIONS

This application claims priority to Chinese Patent Application No. 202411706662.0 filed on Nov. 26, 2024, in China National Intellectual Property Administration, the contents of which are incorporated by reference herein.

### FIELD

The present application relates to the technical field of device detection, and in particular, to a method for detecting abnormalities in equipment and an electronic device.

### BACKGROUND

In order to maintain a piece of equipment in a timely manner, it is necessary to detect whether the piece of equipment is abnormal. In the related technology, it is often directly determined whether the performance data of the equipment is abnormal by a threshold or a threshold range, and an alarm prompt is output when the performance data is determined to be abnormal. However, the above abnormality detection method is difficult to adapt to the complex and variable operating environment and equipment status, and it is easy to have false alarms or missed alarms.

If the abnormality of the equipment cannot be accurately detected, the stable operation and maintenance efficiency of the equipment will be affected.

### BRIEF DESCRIPTION OF THE DRAWINGS

FIG. 1 is a flow chart of a method for detecting abnormalities in equipment provided in an embodiment of the present application.

FIG. 2 is a flow chart of a method for generating correlation weights provided in an embodiment of the present application.

FIG. 3 is a flow chart of a method for fixing an equipment under test provided in an embodiment of the present application.

FIG. 4 is a structure schematic diagram of an electronic device provided in an embodiment of the present application.

### DETAILED DESCRIPTION

In order to make the objectives, technical solutions and advantages of the present application clearer, the present application is described in detail below with reference to the accompanying drawings and specific embodiments.

It should be noted that in this application, “at least one” means one or more, and “more” means two or more than two. “And/or” describes the association relationship of associated objects, indicating that three relationships may exist. For example, A and/or B can mean: A exists alone, A and B exist at the same time, and B exists alone, where A and B can be singular or plural. The terms “first”, “second”, “third”, “fourth”, etc. (if any) in the specification, claims and drawings of this application are used to distinguish similar objects, rather than to describe a specific order or sequence.

In the embodiments of the present application, words such as “exemplary” or “for example” are used to indicate examples, illustrations or descriptions. Any embodiment or design described as “exemplary” or “for example” in the embodiments of the present application should not be interpreted as being more preferred or more advantageous than other embodiments or designs. Specifically, the use of words such as “exemplary” or “for example” is intended to present related concepts in a specific way.

The present application provides a method for detecting abnormalities in equipment, which can accurately detect whether an equipment has abnormalities.

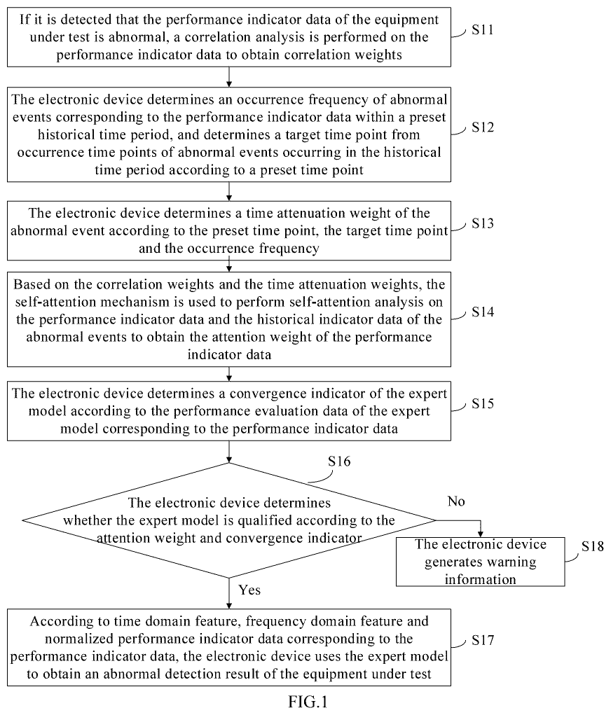

As shown in FIG. 1, provided in the embodiment of the present application can be applied to one or more electronic devices. The electronic device can be a server, an industrial computer, a computer, a mobile phone, a laptop computer, a vehicle-mounted device, etc., wherein the server can be a cloud server or a server cluster. The present application does not limit the type of electronic device.

As shown in FIG. 1, FIG. 1 illustrates a flow chart of a method for detecting abnormalities in equipment provided in an embodiment of the present application. According to different requirements, the order of each step in the flow chart can be adjusted according to actual requirements, and some steps can be omitted. The method is applied to an electronic equipment.

At block S11, if it is detected that the performance indicator data of the equipment under test is abnormal, a correlation analysis is performed on the performance indicator data to obtain correlation weights.

In some embodiments of the present application, the performance indicator data may correspond to a plurality of indicator types, wherein the performance indicator data of each indicator type may be in the form of a vector and have a corresponding time period, such as 60 seconds. The present application does not limit the type of equipment under test. For example, the equipment under test may be a computer and a server, etc. The number of devices under test may be one or more.

The present application does not limit the number of indicator types. For example, the performance indicator data may include data indicating the performance of a central processing unit (CPU), data indicating the performance of a random access memory (RAM), data indicating the performance of a disk input/output (Disk Input/Output, Disk I/O) , data indicating the performance of Dual In-line Memory Module (DIMM), and data indicating the performance of network traffic, where RAM may be referred to as memory.

For example, the performance indicator data of the CPU may include CPU usage, CPU temperature, and CPU error count, etc. The performance indicator data of the memory may include memory usage, available memory, and memory error count, etc. The performance indicator data of the disk may include read delay time, write delay time, total error count, error rate per second, etc. The performance indicator data of the DIMM may include error rate per second, etc. The performance indicator data of the network traffic may include network delay time, packet loss rate, etc.

In some embodiments of the present application, the electronic device may determine whether the performance indicator data of each indicator type is abnormal by a variety of methods, and the present application does not impose any limitation on this.

Exemplarily, the electronic device can calculate a mean value and a standard deviation corresponding to the performance indicator data of any indicator type, and calculate the standard score (referred to as “Z value” or “Z score”) of any performance indicator data of any indicator type according to the mean value and the standard deviation. The electronic device can determine that the performance indicator data corresponding to the standard score greater than the preset score is abnormal data. If there is a first preset number of abnormal data in the performance indicator data of any indicator type, the electronic device can determine that the performance indicator data of any indicator type is abnormal. In one embodiment, the preset score and the first preset number can be customized, and the present embodiment does not limit this.

In some embodiments of the present application, when the performance indicator data corresponds to a plurality of indicator types, the correlation weights may include autocorrelation weights and cross-correlation weights. If the performance indicator data corresponds to a single indicator type, the electronic device may only include the autocorrelation weights. Each indicator type may have multiple cross-correlation weights.

The autocorrelation weights may be obtained by performing a correlation analysis on the performance indicator data of the same indicator type, and the cross-correlation weights may be obtained by performing a correlation analysis on the performance indicator data of the multiple indicator types.

In one embodiment, the correlation between performance indicator data can be reflected by the correlation weights. For example, the autocorrelation weight can reflect the correlation between performance indicator data of the same indicator type, and the cross-correlation weight can reflect the correlation between performance indicator data of different indicator types.

At block S12, the electronic device determines an occurrence frequency of abnormal events corresponding to the performance indicator data within a preset historical time period, and determines a target time point from occurrence time points of abnormal events occurring in the historical time period according to a preset time point.

In some embodiments of the present application, each indicator type has a corresponding abnormal event. For example, the abnormal event corresponding to the CPU may be abnormal CPU usage, and the abnormal event corresponding to the RAM may be abnormal memory usage, and the abnormal event corresponding to the disk may be abnormal disk read and write speed, and the abnormal event corresponding to the DIMM may be DIMM failure, and the abnormal event corresponding to the network traffic may be network delay, etc.

The historical time period can be customized, and the present application does not limit this. For example, the historical time period can be within the past 7 days. The electronic device can count the number of occurrences of each abnormal event within the historical time period, and calculate the frequency of occurrence of each abnormal event based on the number of occurrences. For example, if the historical time period is within the past 7 days, if the abnormal event of excessive CPU load occurred 10 times within the past 7 day, it can be determined that the frequency of occurrence of the abnormal event of excessive CPU load is 10.

In other embodiments of the present application, the electronic device may normalize the number of occurrences of abnormal events in the historical time period according to the historical time period, and determine the normalized value or the value obtained by weighting the normalized value as the frequency of occurrence of the abnormal event. The above examples of the method for determining the frequency of occurrence of abnormal events are only examples and are not limited to this in practical applications.

In some embodiments of the present application, the preset time point can be customized, for example, the electronic device can use the current time point as the preset time point. Exemplarily, the electronic device can determine the occurrence time point closest to the current time point as the target time point.

At block S13, the electronic device determines a time attenuation weight of the abnormal event according to the preset time point, the target time point and the occurrence frequency.

In some embodiments of the present application, determining the time attenuation weight of the abnormal event according to the preset time point, the target time point and the occurrence frequency includes: determining a time interval between the preset time point and the target time point, and using a first preset function to operate on a preset attenuation coefficient and the time interval to obtain a time attenuation factor of the abnormal event, and determining the time attenuation weight of the abnormal event according to the occurrence frequency and the time attenuation factor.

Each type of abnormal event may have a corresponding time attenuation weight. The present application does not limit the type of the first preset function. For example, the first preset function may be an exponential function with the base e of the natural logarithm as the base. The preset attenuation coefficient may be custom set, and the present application does not limit this. For example, the preset attenuation coefficient may be 1.5.

Exemplarily, the electronic device may use a multiplication result of the preset attenuation coefficient and the time interval as the exponent of an exponential function with the base e of the natural logarithm as the base to obtain the time attenuation factor. The above examples of the first preset function are only examples and are not limited to this in practical applications. For example, the first preset function may also be a linear function.

In some embodiments of the present application, each abnormal event may have a corresponding time attenuation weight. The electronic device may multiply the occurrence frequency of each abnormal event by the corresponding time attenuation factor to obtain the time attenuation weight corresponding to each abnormal event.

Considering that the impact of abnormal events changes with the development of time, abnormal events that are closer to the current time point are often more relevant to the current state of the equipment under test than abnormal events that are far away from the current time point. Therefore, in order to quickly and accurately determine whether the equipment under test has an abnormality and the abnormal event when an abnormality occurs, in the embodiment, the occurrence time point closest to the current time point is determined as the target time point, which can make the time attenuation weight of the abnormal event corresponding to the occurrence time point closer to the current time point greater, thereby reducing the interference of the abnormal event corresponding to the occurrence time point farther from the current time.

At block S14, based on the correlation weights and the time attenuation weights, the self-attention mechanism is used to perform self-attention analysis on the performance indicator data and the historical indicator data of the abnormal events to obtain the attention weight of the performance indicator data.

In some embodiments of the present application, based on the correlation weights and the time attenuation weights, the self-attention mechanism is used to perform self-attention analysis on the performance indicator data and the historical indicator data of the abnormal events to obtain the attention weight of the performance indicator data includes: the electronic device uses the self-attention mechanism to convert the performance indicator data into a query vector, and uses the self-attention mechanism to convert the historical indicator data into a key vector, and determines the attention weight according to the query vector, the key vector, the correlation weights and the time attenuation weights.

In one embodiment, the performance indicator data of each indicator type has a corresponding attention weight. The method of converting the performance indicator data into a query vector and converting the historical indicator data into a key vector using the self-attention mechanism can refer to the description of embedding data and linear transformation of the embedded data in the relevant technology.

Exemplarily, the electronic device can calculate an inner product between the query vector and the key vector, and perform addition or weighted addition of the inner product, related weight, and time-decayed weight to obtain the weight sum value, and determine a vector dimension of the query vector or key vector, and determine a ratio between the weight sum value and the square root value of the vector dimension as the attention weight.

In one embodiment, the weights of weighted correlation operations can be customized, and the present application does not restrict this.

In one embodiment, since the correlation weight can reflect the correlation between the performance indicator data, and the time attenuation weight can reflect the degree of influence of abnormal events occurring at different time points on the current state of the equipment under test, the attention weight of the performance indicator data is calculated by the self-attention mechanism by the correlation weight and the time attenuation weight, so that the attention weight can comprehensively reflect the importance and timeliness of the performance indicator data and the contribution to the current state of the equipment under test. For example, the larger the attention weight, the higher the importance and timeliness of the corresponding performance indicator data, and the greater the contribution to the current state of the equipment under test.

At block S15, the electronic device determines a convergence indicator of the expert model according to the performance evaluation data of the expert model corresponding to the performance indicator data.

In some embodiments of the present application, the performance indicator data corresponding to each indicator type may have a corresponding expert model in a mixture of experts (MOE). Exemplarily, following the above embodiment, if the performance indicator data may include data indicating the performance of a central processing unit, data indicating the performance of a memory, data indicating the performance of a disk input/output, data indicating the performance of a dual in-line memory module, and data indicating the performance of network traffic, the MOE may include an expert model corresponding to the performance indicator data of the CPU, an expert model corresponding to the performance indicator data of the memory, an expert model corresponding to the performance indicator data of the disk, an expert model corresponding to the performance indicator data of the DIMM, and an expert model corresponding to the performance indicator data of the network traffic.

In one embodiment, the expert model corresponding to the performance indicator data of each indicator type can be obtained by the corresponding training data. For example, the expert model corresponding to the performance indicator data of the CPU can be obtained by training the neural network using the performance indicator data of the CPU as training data, and the expert model corresponding to the performance indicator data of the memory can be obtained by training the neural network using the performance indicator data of the memory as training data. The neural networks corresponding to the performance indicator data of each indicator type may be the same or different. For example, the hybrid expert model in the present application can be obtained by training the expert models in models such as a Mixtral-8x7B model, a DeepSeekMoE model, a Flan-MoE model and a SmartMoE model with corresponding training data. The expert model corresponding to the performance indicator data of each indicator type in the hybrid expert model can be obtained by independent training or by joint training.

In some embodiments of the present application, the hybrid expert model includes a gating network, and the electronic device can use the gating network to perform feature analysis on performance indicator data of any indicator type, so as to determine the expert model corresponding to the performance indicator data of any indicator type from multiple expert models of the hybrid expert model.

In one embodiment, the method of using the gating network to perform feature analysis on performance indicator data of any indicator type can refer to the description of the gating network in the relevant technology to select the expert model by the type, range, distribution and other characteristics of the data.

In some embodiments of the present application, the performance evaluation data includes precision data and recall data. The electronic device determines the convergence indicator of the expert model according to the performance evaluation data of the expert model corresponding to the performance indicator data, including: determining a harmonic mean of the expert model according to the precision data and the recall data, determining the target value according to the first preset value and the harmonic mean, and using the second preset function to operate the second preset value and the target value to obtain the convergence indicator.

Each expert model has a corresponding convergence indicator. The target value may be a difference between the harmonic mean and the first preset value.

Exemplarily, the electronic device may input labeled sample data into each expert model, and obtain data output by each expert model, and calculate the precision data and the recall data of each expert model according to the output data and the labels of the sample data.

The sample data may be performance indicator data of the equipment, and the annotation of the sample data may be used to indicate whether an abnormality occurs in the equipment and an abnormal event when an abnormality occurs.

The harmonic mean can be called a F1 score. The calculation method of the precision data and the recall data of each expert model can refer to the relevant technology. The calculation method of the harmonic mean can refer to a formula for calculating the F1 score by the precision data and the recall data in the relevant technology.

The second preset function can be customized, and the present application does not limit this. For example, the second preset function can be a sigmoid function. The second preset value can be customized, and the present application does not limit this.

Exemplarily, the electronic device may use a multiplication result of the second preset value and the target value as the exponent of the sigmoid function to obtain a convergence indicator.

In the embodiment, since the convergence indicator of the expert model is obtained by calculating the corresponding performance evaluation data, each convergence indicator can reflect the characteristics such as the performance and convergence degree of the corresponding expert model.

At block S16, the electronic device determines whether the expert model is qualified according to the attention weight and convergence indicator.

In some embodiments of the present application, determining whether the expert model is qualified according to the attention weight and convergence indicator, includes: if the convergence indicator of the expert model corresponding to any indicator type is greater than or equal to a first preset value, and the attention weight corresponding to the performance indicator data of any indicator type is greater than or equal to a second preset value, the electronic device can determine that the expert model corresponding to any indicator type is qualified; if the convergence indicator of the expert model corresponding to any indicator type is less than the first preset value, the electronic device can determine that the expert model corresponding to any indicator type is unqualified.

In one embodiment, the first preset value and the second preset value can be customized, and the present application does not limit this.

In some embodiments of the present application, if the expert model corresponding to any indicator type is qualified, block S17 is executed; if the expert model corresponding to any indicator type is unqualified, block S18 is executed.

In the embodiment, since each convergence indicator can reflect the performance and convergence degree of the corresponding expert model, the attention weight can fully reflect the importance, timeliness and contribution of the performance indicator data to the current state of the equipment under test. Therefore, the attention weight of the performance indicator data and the convergence indicator of each expert model are used to determine whether the corresponding expert model is qualified. It is not only possible to determine the expert model corresponding to the performance indicator data of each indicator type, but also to accurately and comprehensively evaluate the reliability and applicability of the expert model. Through the convergence indicator, the expert model that has not yet converged or has poor performance can be controlled not to be called/activated, thereby ensuring the detection accuracy of the equipment under test.

In other embodiments of the present application, the expert model in the MOE can be adjusted according to the indicator type of the performance indicator data. For example, if the temperature data of the equipment under test is added to the performance indicator data, the expert model corresponding to the temperature data of the equipment under test can be added to the MOE. If the CPU usage rate is reduced in the performance indicator data, the expert model corresponding to the CPU usage rate can be deleted from the MOE or the expert model corresponding to the CPU usage rate can be controlled not to be called/activated by setting the convergence indicator and/or attention weight.

At block S17, according to time domain feature, frequency domain feature and normalized performance indicator data corresponding to the performance indicator data, the electronic device uses the expert model to obtain an abnormal detection result of the equipment under test.

In some embodiments of the present application, the performance indicator data of each indicator type has a corresponding time domain feature. The electronic device can calculate the time domain feature of the performance indicator data and can calculate the mean, rate of change, variance, standard deviation and root mean square value of the performance indicator data of each indicator type as the time domain feature corresponding to each indicator type.

In the embodiment, the time domain feature can reflect the statistical characteristics and change trends of the corresponding performance indicator data in the time dimension. By calculating the time domain feature such as the mean, change rate, variance, standard deviation and root mean square value of the performance indicator data of each indicator type, the distribution law and fluctuation of the performance indicator data at different times can be known.

In some embodiments of the present application, the performance indicator data of each indicator type has a corresponding frequency domain feature. The electronic device can perform frequency domain transformation on the performance indicator data of each indicator type to obtain spectrum data, and extract the frequency domain feature corresponding to each indicator type from the spectrum data.

The present application does not limit the method of frequency domain transformation. For example, the frequency domain transformation may be a Fourier transform. The frequency domain feature may include multiple frequency domain components. For example, the frequency domain feature may include a DC component, a baseband component, and a highest frequency component in the spectrum data.

In the embodiment, the frequency domain feature can reflect the components and distribution of the corresponding performance indicator data in the frequency dimension. By performing frequency domain transformation on the performance indicator data and extracting frequency domain features such as the DC component, baseband component and highest frequency component in the spectrum data, the energy distribution and periodicity characteristics of the performance indicator data at different frequencies can be analyzed.

In some embodiments of the present application, the electronic device may preset a numerical range and normalize the performance indicator data of each indicator type to obtain normalized performance indicator data. The preset numerical range may be customizable. For example, the preset numerical range may be 0 to 1.

In the embodiment, the performance indicator data of each indicator type is normalized to eliminate the influence caused by the different dimensions and value ranges between different performance indicator data, so that the normalized performance indicator data are on the same comparable scale.

In some embodiments of the present application, each indicator type has corresponding time domain feature, frequency domain feature and normalized performance indicator data, and each indicator type has corresponding abnormal events. The electronic device obtains the abnormal detection result of the equipment under test according to the time domain feature, frequency domain feature and normalized performance indicator data corresponding to the performance indicator data using an expert model, including: according to the time domain feature, the frequency domain feature and the normalized performance indicator data corresponding to any indicator type, using the expert model corresponding to any indicator type to predict the probability of the abnormal event corresponding to any indicator type occurring in the equipment under test; if the probability is greater than or equal to a third preset value, determining that the abnormal detection result is that the equipment under test has the abnormal event corresponding to any indicator type; if the probability is less than the third preset value, determining that the abnormal detection result is that the equipment under test does not have the abnormal event corresponding to any indicator type.

In one embodiment, the third preset value can be customized, and the application does not impose any restrictions on this.

The method for using the expert model corresponding to any indicator type, and predicting the probability of an abnormal event corresponding to any indicator type occurring in the equipment under test according to the time domain feature, the frequency domain feature and normalized performance indicator data corresponding to any indicator type, can refer to the data processing method of the expert model in the relevant technology.

In the embodiment, when determining that the expert model corresponding to the performance indicator data of any indicator type is reliable and adapted to the performance indicator data, since the time domain feature can reflect the statistical characteristics and change trends of the corresponding performance indicator data in the time dimension, the frequency domain feature can reflect the components and distribution of the corresponding performance indicator data in the frequency dimension, and the normalized performance indicator data are on the same comparable scale, based on the time domain feature, the frequency domain feature and normalized performance indicator data corresponding to any indicator type, using the expert model corresponding to any indicator type, the probability of an abnormal event corresponding to any indicator type occurring in the equipment under test can be predicted, and the risk of an abnormal event corresponding to any indicator type occurring in the equipment under test can be accurately determined, thereby enabling accurate detection of device abnormalities.

At block S18, the electronic device generates warning information.

In some embodiments of the present application, the warning information can be used to indicate that the expert model is unqualified, that the performance indicator data corresponding to the unqualified expert model cannot be analyzed, and that the unqualified expert model is adjusted. The content of the warning information can be customized, and the present application does not limit this.

In the embodiment, when the expert model fails to meet the standards, an alarm message is generated, so that the user can take effective measures in time to adjust and optimize the failed expert model, thereby ensuring accurate detection of the equipment under test.

In other embodiments of the present application, when it is determined that the expert model is unqualified, the electronic device can adjust the parameters of the expert model to optimize the parameters of the expert model, and the optimized expert model can be used as a new expert model in a hybrid expert model (for example MOE) or can replace the corresponding original expert model in the hybrid expert model. For example, the LoRA technology can be used to adjust the unqualified expert model by introducing a low-rank matrix into the weight matrix of the unqualified expert model.

In the method for detecting abnormalities in equipment of the embodiment, the correlation weight can reflect the degree of correlation between the performance indicator data, and the time attenuation weight can reflect the degree of influence of abnormal events occurring at different time points on the current state of the equipment under test. Therefore, the attention weight of the performance indicator data is calculated by the self-attention mechanism by the correlation weight and the time attenuation weight, so that the attention weight can fully reflect the importance and timeliness of the performance indicator data and the contribution to the current state of the equipment under test. Since the convergence indicator of the expert model is obtained by calculating the corresponding performance evaluation data, each convergence indicator can reflect the performance and convergence characteristics of the corresponding expert model. Since each convergence indicator can reflect the performance and convergence characteristics of the corresponding expert model, the attention weight can fully reflect the importance, timeliness and contribution of the performance indicator data to the current state of the equipment under test. Therefore, by the attention weight of the performance indicator data and the convergence indicator of each expert model, it is determined whether the corresponding expert model is qualified, which can not only determine the expert model corresponding to the performance indicator data of each indicator type, but also accurately and comprehensively evaluate the reliability and applicability of the expert model. The time domain feature can reflect the statistical characteristics and the change trends of the corresponding performance indicator data in the time dimension, the frequency domain feature can reflect the components and distribution of the corresponding performance indicator data in the frequency dimension, and the normalized performance indicator data are on the same comparable scale. Therefore, when determining whether the expert model is qualified, based on the time domain features, frequency domain features and normalized performance indicator data, and the qualified expert model, it is possible to accurately determine a risk of abnormal events corresponding to the performance indicator data of the equipment under test, thereby enabling accurate detection of device abnormalities.

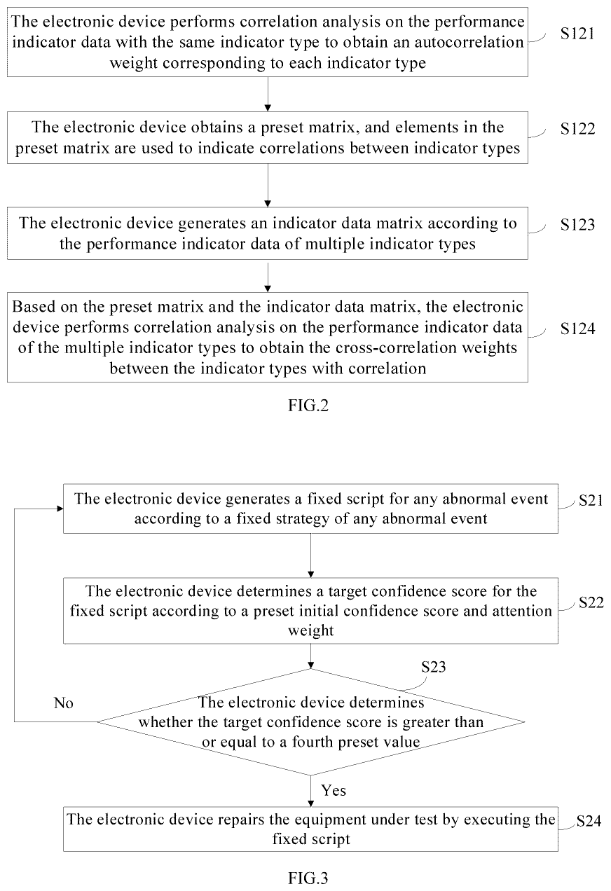

For example, as shown in FIG. 2, it is a flow chart of a method for generating correlation weights provided in an embodiment of the present application, comprising the following steps.

At block S121, the electronic device performs correlation analysis on the performance indicator data with the same indicator type to obtain an autocorrelation weight corresponding to each indicator type.

In some embodiments of the present application, the performance indicator data of each indicator type may have a corresponding autocorrelation weight. The electronic device may count the number of indicator data of the performance indicator data of each indicator type, select a second preset number of time-continuous multiple performance indicator data from the performance indicator data of each indicator type, obtain multiple groups of performance indicator data, wherein the performance indicator data between the multiple groups of performance indicator data may partially overlap, perform multiplication operation or weighted multiplication operation on multiple performance indicator data in each group of performance indicator data, obtain first products, and perform addition operation or weighted addition operation on the first products of the multiple groups of performance indicator data, and obtain a first sum value, and determine the ratio between the first sum value and the number of indicator data as the autocorrelation weight corresponding to each indicator type.

The second preset number of the selected multiple performance indicator data can be customized, and the present application does not limit this. For example, the second preset number can be two.

The weighted multiplication operation and weighted addition operations can be customized, and the present application does not impose any restrictions on this.

In the embodiment, since the autocorrelation weight can reflect the degree of correlation between performance indicator data with the same indicator type, the performance indicator data with the same indicator type is subjected to correlation analysis to obtain the autocorrelation weight corresponding to each indicator type, so as to determine the stability of the performance indicator data of the indicator type, so as to determine whether the equipment under test is abnormal. For example, if the autocorrelation weight of the performance indicator data of an indicator type is high, it can represent that the stability of the performance indicator data is good, and the risk of abnormality of the structure (for example, CPU or RAM) corresponding to the performance indicator data in the equipment under test is low, or if the autocorrelation weight of the performance indicator data of an indicator type is low, it can represent that the performance indicator data has large fluctuations or abnormalities, and the risk of abnormality of the structure corresponding to the performance indicator data in the equipment under test is high.

At block S122, the electronic device obtains a preset matrix, and elements in the preset matrix are used to indicate correlations between indicator types.

In some embodiments of the present application, the preset matrix can be customized. For example, if there is a positive correlation between the analysis indicators, the element representing the positive correlation in the preset matrix can be set to 1, and the other elements in the preset matrix can be set to 0. If there is a negative correlation between the analysis indicators, the element representing the negative correlation can be set to −1, and the other elements in the preset matrix can be set to 0. The elements in the preset matrix that are not 0 (for example, 1 and −1) can be distributed diagonally.

At block S123, the electronic device generates an indicator data matrix according to the performance indicator data of multiple indicator types.

In some embodiments of the present application, each column/row of indicator data in the indicator data matrix corresponds to an indicator type.

Exemplarily, the electronic device may use the performance indicator data having the same indicator type as column data to construct the indicator data matrix, so that each column of indicator data in the indicator data matrix corresponds to an indicator type.

At block S124, based on the preset matrix and the indicator data matrix, the electronic device performs correlation analysis on the performance indicator data of the multiple indicator types to obtain the cross-correlation weights between the indicator types with correlation.

Exemplarily, the electronic device performs correlation analysis on the performance indicator data of the multiple indicator types to obtain the cross-correlation weights between the indicator types with correlation, including: executing a matrix filling process, including: generating an empty matrix according to the dimension of the preset matrix, selecting a target indicator type from the multiple indicator types, filling the empty matrix with the performance indicator data corresponding to the target indicator type in the indicator data matrix, obtaining an initial matrix, keeping the performance indicator data corresponding to the target indicator type unchanged in the initial matrix, cyclically selecting the performance indicator data corresponding to the indicator type of the number of rows or columns to be filled in the initial matrix from the indicator data matrix, and filling the selected performance indicator type in the initial matrix until all the performance indicator data corresponding to the indicator types in the indicator data matrix are selected,, and obtaining multiple target matrices corresponding to the target indicator type, repeating the matrix filling process until the multiple indicator types are all selected as the target indicator types and then stopped. Multiple target matrices corresponding to each indicator type are obtained, wherein each target matrix has corresponding multiple indicator types, and the cross-correlation weights between the multiple indicator types corresponding to each target matrix are determined according to the preset matrix and each target matrix. If the cross-correlation weight corresponding to any target matrix is greater than the preset threshold, it is determined that the multiple indicator types corresponding to any target matrix are correlated.

The number of columns of the empty matrix may be the same as the number of rows of the preset matrix, or the number of rows of the empty matrix may be the same as the number of columns of the preset matrix. For example, if the dimension of the preset matrix is m*n, the dimensions of the empty matrix may be q*m, n*k.n*m.

An indicator type may be selected from the plurality of indicator types as a target indicator type, wherein the indicator types selected from the plurality of indicator types each time are not repeated.

The number of rows/columns to be filled may be the number of empty rows/columns. The preset threshold may be customized, and the application does not impose any restrictions on this.

For example, taking the analysis of the correlation between the performance indicator data of the CPU and the performance indicator data of other indicator types as an example, if the performance indicator data of the CPU corresponds to the first column of data in the indicator data matrix, the first column of data can be selected from the indicator data matrix to fill in the first column of the initial matrix. If the number of columns to be filled in the initial matrix is 3 columns, the performance indicator data of the second column, the third column and the fourth column are selected from the indicator data matrix to fill in the second column, the third column and the fourth column in the initial matrix to obtain the first target matrix; the electronic device can keep the first column of data unchanged in the initial matrix, select the performance indicator data of the third column, the fourth column and the fifth column from the indicator data matrix to fill in the second column, the third column and the fourth column in the initial matrix to obtain the second target matrix. The electronic device can keep the first column of data unchanged in the initial matrix, select the performance indicator data of the fourth column, the fifth column and the sixth column from the indicator data matrix to fill in the second column, the third column and the fourth column in the initial matrix to obtain the third target matrix. And so on, until the performance indicator data of all indicator types in the indicator data matrix are selected, multiple target matrices corresponding to the performance indicator data of the CPU can be obtained. The above matrix filling process is repeated until all indicator types are selected as target indicator types and then stopped, and multiple target matrices corresponding to the performance indicator data of each indicator type can be obtained.

The electronic device can calculate the cross-correlation weights between multiple indicator types corresponding to any one of the target matrices according to the preset matrix and any one of the target matrices by a variety of methods. Exemplarily, the electronic device can multiply the preset matrix with the corresponding elements in any one of the target matrices to obtain second products, perform an addition operation or a weighted addition operation on the second products to obtain a second sum value, and determine the second sum as the cross-correlation weights between multiple indicator types corresponding to any one of the target matrices.

In the embodiment, by generating multiple target matrices corresponding to each indicator type, and determining the cross-correlation weights between the multiple indicator types corresponding to each target matrix according to the preset matrix and each target matrix, the correlation relationship and correlation degree between the performance indicator data of multiple indicator types can be comprehensively analyzed, so that the performance indicator data with mutual influence in data changes can be determined. Since the cross-correlation weights can reflect the correlation degree between the performance indicator data of different multiple indicator types, the performance indicator data of the multiple indicator types are subjected to correlation analysis to obtain the cross-correlation weights between the indicator types with correlation, so as to determine the potential correlation and influence relationship between the performance indicator data of multiple indicator types, so as to comprehensively determine the abnormality of the equipment under test and accurately determine the root cause of the abnormality of the equipment under test.

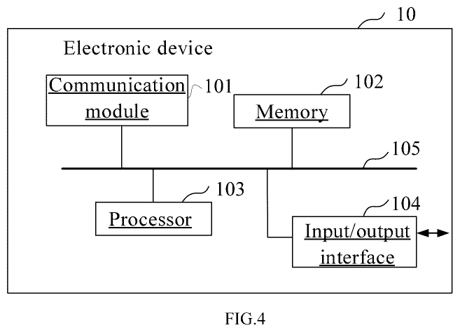

In some embodiments of the present application, if it is determined that any abnormal event occurs in the equipment under test, the electronic device can fix the equipment under test. For example, as shown in FIG. 3, it is a flow chart of a method for fixing an equipment under test provided in an embodiment of the present application. The method includes the following steps.

At block S21, the electronic device generates a fixed script for any abnormal event according to a fixed strategy of any abnormal event.

In some embodiments of the present application, the fixed strategy may include a repair operation, description information of the repair operation, configuration parameters, and the like.

Exemplarily, the electronic device may use the repair strategies and fixed scripts of multiple abnormal events as training samples to train the model, input the fixed strategy of any abnormal event into the trained model, and obtain the fixed script for any abnormal event.

The present application does not limit the type of model. For example, the model may be a sequence-to-sequence (Seq2Seq) model and a generative adversarial network (GAN). The trained model may convert the fixed strategy into instructions and operations to obtain a fixed script.

At block S22, the electronic device determines a target confidence score for the fixed script according to a preset initial confidence score and attention weight.

In some embodiments of the present application, the initial confidence score can be customized, and the present application does not limit this. For example, the initial confidence score can be 0.5.

In some embodiments of the present application, the electronic device may perform a multiplication operation or a weighted multiplication operation on the initial confidence score and the attention weight of the performance indicator data corresponding to the abnormal event to obtain a target confidence score. In the embodiment, the weight used for the weighted multiplication operation may be custom set.

In the embodiment, since the attention weight can comprehensively reflect the importance, timeliness and contribution of the performance indicator data to the current state of the equipment under test, the target confidence score of the fixed script is calculated according to the attention weight, which can accurately quantify the repair reliability of the fixed script for abnormal events.

At block S23, the electronic device determines whether the target confidence score is greater than or equal to a fourth preset value.

In some embodiments of the present application, the fourth preset value can be customized, and the present application does not limit this. By comparing the target confidence score with the fourth preset value, the reliability of the fixed script can be accurately evaluated.

In the embodiment, if the target confidence score is greater than or equal to the fourth preset value, block S24 is executed; if the target confidence score is greater than or equal to the fourth preset value, the process returns to block S21.

At block S24, the electronic device repairs the equipment under test by executing the fixed script.

In the embodiment, when the target information score is greater than or equal to the fourth preset value, it means that the reliability of the fixed script is high. By executing the fixed script to fix the equipment under test, the repair success rate of the equipment under test can be ensured.

In other embodiments of the present application, before executing the fixed script, the fixed script may be tested at least once, and whether to execute the fixed script is determined according to the test result. For example, when the test result indicates that the fixed script can successfully repair the anomaly, the initial confidence score may be increased to increase the probability that the fixed script can be executed.

In one embodiment, the electronic device can use artificial intelligence (AI) technology to generate a Chain-of-Thought (CoT) by analyzing the fixed script and the current status of the equipment under test. The CoT can be a series of logical reasoning and judgments on the fixed script before the fixed script is executed. Through the CoT, the electronic device can determine whether there are logical problems in the fixed script, such as whether the sequence of steps is reasonable, whether there are contradictory operations, whether the status or limitations of the equipment under test are considered, etc.

For example, if the fixed script contains instructions to delete files, the electronic device can determine whether the target file to be deleted exists and whether the user has permission to delete the target file. If the target file exists and the user has permission to delete it, the electronic device can determine that the instruction to delete the file is reasonable.

For example, for each program or instruction in the fixed script that may affect the state or data of the equipment under test (for example, deletion instructions, modification instructions, configuration instructions, and restart instructions, etc.), before execution, the electronic device may first perform a confirmation process, and the confirmation process may include determining whether the state of the equipment under test allows the execution of the instruction by AI, and evaluating the consequences of the execution of the instruction, etc. After all instructions have passed the above confirmation process and have been confirmed by the user, the electronic device can determine that the instruction is reasonable. Exemplarily, if the fixed script includes a capacity expansion instruction, the electronic device can determine whether the equipment under test includes spare resources, and determine whether the specifications of the spare resources (for example, capacity) meet the requirements of the capacity expansion instruction. When the spare specifications meet the requirements of the capacity expansion instruction, the electronic device can determine that the state of the equipment under test allows the execution of the capacity expansion instruction.

For example, when the fixed script includes a query instruction, if the query instruction is only for obtaining information and does not affect the state or data of the equipment under test, the execution of the query instruction may not be confirmed by the above confirmation process. However, if the result of the query instruction is referenced by a subsequent program or instruction, the execution of the query instruction may be confirmed through the above confirmation process.

In the embodiment, by testing the fixed script, the security, rationality, accuracy and feasibility of the fixed script can be ensured, thereby reducing damage or data loss to the equipment under test caused by the execution of the fixed script.

In other embodiments, the electronic device may determine whether the electronic device has the authority to automatically execute the fixed script according to the importance level of the abnormal event. The importance level of each abnormal event may be customized. For example, the importance level may be high, medium, or low. The importance level corresponding to an abnormal event related to the CPU may be high, and the importance level corresponding to an abnormal event related to a sensor monitoring room temperature may be low.

The fixed scripts corresponding to abnormal events with lower importance levels and the fixed scripts corresponding to abnormal events with higher importance levels can be executed after confirmation by the user. For example, the electronic device can automatically execute the fixed scripts corresponding to abnormal events with low or low and medium importance levels, and the fixed scripts corresponding to abnormal events with high importance levels can be executed after confirmation by the user.

In the embodiment, when the electronic device confirms that it has the corresponding authority and determines that the fixed script is accurate and feasible by the thought chain, the electronic device can execute the fixed script. During the execution process, the electronic device can adjust and optimize the fixed script according to the real-time feedback of the equipment under test and the change of the equipment status to ensure the repair effect.

As shown in FIG. 4, it is a structure schematic diagram of an electronic device provided in an embodiment of the present application. As shown in FIG. 4, the electronic device 10 may include a communication module 101, a memory 102, a processor 103, an input/output (I/O) interface 104 and a bus 105. The processor 103 is coupled to the communication module 101, the memory 102, and the input/output interface 104 by the bus 105.

The communication module 101 may include a wired communication module and/or a wireless communication module. The wired communication module may provide one or more wired communication solutions such as universal serial bus (USB), controller area network bus (CAN, Controller Area Network). The wireless communication module may provide one or more wireless communication solutions such as wireless fidelity, Bluetooth, mobile communication network, frequency modulation (FM), near field communication technology (NFC), infrared technology (IR), etc.

The memory 102 may include one or more random access memories (RAM) and one or more non-volatile memories (NVM). The random access memory may be directly read and written by the processor 103, and may be used to store executable programs (such as machine instructions) of other running programs, and may also be used to store user and application data, etc. The random access memory may include static random-access memory (SRAM), dynamic random access memory (DRAM), synchronous dynamic random access memory (SDRAM), double data rate synchronous dynamic random access memory (DDR SDRAM) , etc.

The non-volatile memory may also store executable programs and user and application data, etc., and may be loaded into the random access memory in advance for direct reading and writing by the processor 103. The non-volatile memory may include a disk storage device and a flash memory.

The memory 102 is used to store one or more computer programs. The one or more computer programs are configured to be executed by the processor 103. The one or more computer programs include multiple instructions, and when the multiple instructions are executed by the processor 103, the equipment abnormality detection method executed on the electronic device 10 can be implemented.

In other embodiments, the electronic device 10 shown in FIG. 4 further includes an external memory interface for connecting to an external memory to expand the storage capacity of the electronic device 10.

The processor 103 may include one or more processing units, for example, the processor 103 may include an application processor (AP), a modem processor, a graphics processor (GPU), an image signal processor (ISP), a controller, a video codec, a digital signal processor (DSP), and/or a neural-network processing unit (NPU), etc. Different processing units may be independent devices or integrated into one or more processors.

The processor 103 provides computing and control capabilities. For example, the processor 103 is used to execute a computer program stored in the memory 102 to implement the above-mentioned method for detecting abnormalities in equipment.

The input/output interface 104 is used to provide a channel for user input or output. For example, the input/output interface 104 can be used to connect various input and output devices, such as a mouse, keyboard, touch device, display screen, etc., so that the user can enter information or visualize information.

The bus 105 is at least used to provide a channel for mutual communication among the communication module 101, the memory 102, the processor 103, and the input/output interface 104 in the electronic device 10.

It is to be understood that the structure illustrated in the embodiment of the present application does not constitute a specific limitation on the electronic device 10. In other embodiments of the present application, the electronic device 10 may include more or fewer components than shown in the figure, or combine some components, or split some components, or arrange the components differently. The components shown in the figure may be implemented in hardware, software, or a combination of software and hardware.

An embodiment of the present application further provides a computer-readable storage medium, on which a computer program is stored. The computer program includes program instructions. The method implemented when the program instructions are executed can refer to the methods in the above-mentioned embodiments of the present application.

In one embodiment, an internal memory of the electronic device described in the above embodiment, for example, a hard disk or memory of the electronic device. The computer-readable storage medium may also be an external storage device of the electronic device, for example, a plug-in hard disk, a smart memory card (SMC), a secure digital (SD) card, a flash card, etc., equipped on the electronic device.

In some embodiments, the computer-readable storage medium may include a program storage area and a data storage area, wherein the program storage area may store an operating system, an application required for at least one function, etc. The data storage area may store data created according to the use of the electronic device, etc.

In the above embodiments, the description of each embodiment has its own emphasis. For parts that are not described or recorded in detail in a certain embodiment, reference can be made to the relevant descriptions of other embodiments.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of this application.

The above embodiments are only used to illustrate the technical solutions of the present application, rather than to limit them. Although the present application has been described in detail with reference to the aforementioned embodiments, those skilled in the art should understand that they can still modify the technical solutions described in the aforementioned embodiment or make equivalent replacements for some of the technical features therein. These modifications or replacements do not deviate the essence of the corresponding technical solutions from the spirit and scope of the technical solutions of the embodiments of the present application, and should all be included in the protection scope of the present application.

What is claimed is:

1. A method for detecting abnormalities of equipment, comprising:
in responses that performance indicator data of equipment under test is detected to be abnormal, obtaining correlation weights by performing a correlation analysis on the performance indicator data;
determining an occurrence frequency of an abnormal event corresponding to the performance indicator data within a preset historical time period, and determining a target time point from occurrence time points of the abnormal event that occurred within the preset historical time period according to a preset time point;
determining a time attenuation weight of the abnormal event according to the preset time point, the target time point and the occurrence frequency;
based on the correlation weights and the time attenuation weight, obtaining an attention weight of the performance indicator data by performing a self-attention analysis on the performance indicator data and historical indicator data of the abnormal event using a self-attention mechanism;
determining a convergence indicator of an expert model according to performance evaluation data of the expert model corresponding to the performance indicator data;
in response that the expert model is determined to be qualified according to the attention weight and the convergence indicator, obtaining an abnormal detection result of the equipment under test by using the expert model according to a time domain feature, a frequency domain feature and normalized performance indicator data corresponding to the performance indicator data.

2. The method as recited in claim 1, wherein the performance indicator data corresponds to a plurality of indicator types, the correlation weights comprises an autocorrelation weight and a cross-correlation weight, wherein obtaining the correlation weights by performing the correlation analysis on the performance indicator data comprises:
obtaining the autocorrelation weight corresponding to each of the plurality of indicator types by performing a correlation analysis on the performance indicator data with a same indicator type;
obtaining a preset matrix, elements in the preset matrix being configured to indicate correlations between the plurality of indicator types;
generating an indicator data matrix according to the performance indicator data of the plurality of indicator types, each column and each row of the indicator data in the indicator data matrix corresponding to an indicator type;
obtaining the cross-correlation weight between correlated indicator types by performing the correlation analysis on the plurality of indicator types according to the preset matrix and the indicator data matrix.

3. The method as recited in claim 2, wherein obtaining the cross-correlation weight between correlated indicator types by performing the correlation analysis on the plurality of indicator types according to the preset matrix and the indicator data matrix, comprising:
executing a matrix filling process, comprising:
generating an empty matrix according to a dimension of a preset matrix;
obtaining an initial matrix by selecting a target indicator type from the plurality of indicator types, and filling the empty matrix with the performance indicator data corresponding to the target indicator type in the indicator data matrix;
keeping the performance indicator data corresponding to the target indicator type unchanged in the initial matrix, cyclically selecting the performance indicator data corresponding to the indicator type of the number of rows or columns to be filled in the initial matrix from the indicator data matrix, and filling selected performance indicator data into the initial matrix until the performance indicator data corresponding to all indicator types in the indicator data matrix have been selected, and obtaining a plurality of target matrices corresponding to the target indicator type;
obtaining the plurality of target matrices corresponding to each indicator type by repeating the matrix filling process until all of the plurality of indicator types have been selected as target indicator types, wherein each target matrix has corresponding indicator types;
determining the cross-correlation weight between the plurality of indicator types corresponding to each target matrix according to the preset matrix and each target matrix;
in response that the cross-correlation weight corresponding to any target matrix is greater than a preset threshold, determining that the plurality of indicator types corresponding to any target matrix are correlated.

4. The method as recited in claim 2, wherein the performance indicator data of each of the plurality of indicator types has a corresponding expert model, and the method further comprises:
in response that the convergence indicator of the expert model corresponding to any indicator type is greater than or equal to a first preset value, and the attention weight corresponding to the performance indicator data of any indicator type is greater than or equal to a second preset value, determining that the expert model corresponding to any indicator type is qualified;
in response that the convergence indicator of the expert model corresponding to any indicator type is less than the first preset value, determining that the expert model corresponding to any indicator type is unqualified, and generating an alarm message.

5. The method as recited in claim 2, wherein each of the plurality of indicator types has a corresponding time domain feature, a frequency domain feature and normalized performance indicator data, each of the plurality of indicator types has corresponding abnormal events,
wherein obtaining the abnormal detection result of the equipment under test by using the expert model according to the time domain feature, the frequency domain feature and the normalized performance indicator data corresponding to the performance indicator data, comprises:
based on the time domain feature, the frequency domain feature and normalized performance indicator data corresponding to any indicator type, predicting a probability value of an abnormal event corresponding to any indicator type occurring in the equipment under test using the expert model corresponding to any indicator type;
in response that the probability value is greater than or equal to a third preset value, determining that the abnormal detection result indicates that the equipment under test has an abnormal event corresponding to any one of the plurality of indicator types;
in response that the probability value is less than the third preset value, determining that the abnormal detection result indicates that the equipment under test does not have any abnormal event corresponding to any of the indicator types.

6. The method as recited in claim 5, wherein in response that determining that the abnormal detection result is that the equipment under test has any abnormal event, the method further comprises:
generating a fixed script for any abnormal event according to a fixed strategy of any abnormal event;
determining a target confidence score for the fixed script according to a preset initial confidence score and the attention weight;
in response that the target confidence score is greater than or equal to a fourth preset value, fixing the equipment under test by executing the fixed script.

7. The method as recited in claim 1, wherein determining the time attenuation weight of the abnormal event according to the preset time point, the target time point and the occurrence frequency comprises:
determining a time interval between the preset time point and the target time point;
obtaining a time attenuation factor of the abnormal event by using a first preset function to calculate a preset attenuation coefficient and the time interval;
determining the time attenuation weight of the abnormal event according to the occurrence frequency and the time attenuation factor.

8. The method as recited in claim 1, wherein based on the correlation weights and the time attenuation weight, obtaining the attention weight of the performance indicator data by performing the self-attention analysis on the performance indicator data and the historical indicator data of the abnormal event using the self-attention mechanism, comprises:
converting the performance indicator data into a query vector using the self-attention mechanism, and converting the historical indicator data into a key vector using the self-attention mechanism;
determining the attention weight according to the query vector, the key vector, the correlation weights and the time attenuation weight.

9. The method as recited in claim 1, wherein the performance evaluation data comprises precision data and recall data,
wherein determining the convergence indicator of the expert model according to the performance evaluation data of the expert model corresponding to the performance indicator data, comprising:
determining a harmonic mean of the expert model according to the precision data and the recall data;
determining a target value according to the first preset value and the harmonic mean;
obtaining the convergence indicator by using a second preset function to calculate a second preset value and the target value.

10. The method as recited in claim 9, wherein the second preset function is a sigmoid function.

11. An electronic device comprising:
a processor; and
a non-transitory storage medium coupled to the processor and configured to store a plurality of instructions, which cause the processor to:
in responses that performance indicator data of equipment under test is detected to be abnormal, obtain correlation weights by performing a correlation analysis on the performance indicator data;
determine an occurrence frequency of an abnormal event corresponding to the performance indicator data within a preset historical time period, and determine a target time point from occurrence time points of the abnormal event that occurred within the preset historical time period according to a preset time point;
determine a time attenuation weight of the abnormal event according to the preset time point, the target time point and the occurrence frequency;
based on the correlation weights and the time attenuation weight, obtain an attention weight of the performance indicator data by performing a self-attention analysis on the performance indicator data and historical indicator data of the abnormal event using a self-attention mechanism;
determine a convergence indicator of an expert model according to performance evaluation data of the expert model corresponding to the performance indicator data;
in response that the expert model is determined to be qualified according to the attention weight and the convergence indicator, obtain an abnormal detection result of the equipment under test by using the expert model according to a time domain feature, a frequency domain feature and normalized performance indicator data corresponding to the performance indicator data.

12. The electronic device as recited in claim 11, wherein the performance indicator data corresponds to a plurality of indicator types, the correlation weights comprises an autocorrelation weight and a cross-correlation weight, wherein the plurality of instructions are further configured to cause the processor to:
obtain the autocorrelation weight corresponding to each of the plurality of indicator types by performing a correlation analysis on the performance indicator data with a same indicator type;
obtain a preset matrix, elements in the preset matrix being configured to indicate correlations between the plurality of indicator types;
generate an indicator data matrix according to the performance indicator data of the plurality of indicator types, each column and each row of the indicator data in the indicator data matrix corresponding to an indicator type;
obtain the cross-correlation weight between correlated indicator types by performing the correlation analysis on the plurality of indicator types according to the preset matrix and the indicator data matrix.

13. The electronic device as recited in claim 12, wherein the plurality of instructions are further configured to cause the processor to:
execute a matrix filling process, comprising:
generating an empty matrix according to a dimension of a preset matrix;
obtaining an initial matrix by selecting a target indicator type from the plurality of indicator types, and filling the empty matrix with the performance indicator data corresponding to the target indicator type in the indicator data matrix;
keeping the performance indicator data corresponding to the target indicator type unchanged in the initial matrix, cyclically selecting the performance indicator data corresponding to the indicator type of the number of rows or columns to be filled in the initial matrix from the indicator data matrix, and filling selected performance indicator data into the initial matrix until the performance indicator data corresponding to all indicator types in the indicator data matrix have been selected, and obtaining a plurality of target matrices corresponding to the target indicator type;
obtain the plurality of target matrices corresponding to each indicator type by repeating the matrix filling process until all of the plurality of indicator types have been selected as target indicator types, wherein each target matrix has corresponding indicator types;
determine the cross-correlation weight between the plurality of indicator types corresponding to each target matrix according to the preset matrix and each target matrix;
in response that the cross-correlation weight corresponding to any target matrix is greater than a preset threshold, determine that the plurality of indicator types corresponding to any target matrix are correlated.

14. The electronic device as recited in claim 12, wherein the plurality of instructions are further configured to cause the processor to:
in response that the convergence indicator of the expert model corresponding to any indicator type is greater than or equal to a first preset value, and the attention weight corresponding to the performance indicator data of any indicator type is greater than or equal to a second preset value, determine that the expert model corresponding to any indicator type is qualified;
in response that the convergence indicator of the expert model corresponding to any indicator type is less than the first preset value, determine that the expert model corresponding to any indicator type is unqualified, and generate an alarm message.

15. The electronic device as recited in claim 12, wherein each of the plurality of indicator types has a corresponding time domain feature, a frequency domain feature and normalized performance indicator data, each of the plurality of indicator types has corresponding abnormal events,
wherein the plurality of instructions are further configured to cause the processor to:
based on the time domain feature, the frequency domain feature and normalized performance indicator data corresponding to any indicator type, predict a probability value of an abnormal event corresponding to any indicator type occurring in the equipment under test using the expert model corresponding to any indicator type;
in response that the probability value is greater than or equal to a third preset value, determine that the abnormal detection result indicates that the equipment under test has an abnormal event corresponding to any one of the plurality of indicator types;
in response that the probability value is less than the third preset value, determine that the abnormal detection result indicates that the equipment under test does not have any abnormal event corresponding to any of the indicator types.

16. The electronic device as recited in claim 15, wherein the plurality of instructions are further configured to cause the processor to:
generate a fixed script for any abnormal event according to a fixed strategy of any abnormal event;
determine a target confidence score for the fixed script according to a preset initial confidence score and the attention weight;
in response that the target confidence score is greater than or equal to a fourth preset value, fix the equipment under test by executing the fixed script.

17. The electronic device as recited in claim 11, wherein the plurality of instructions are further configured to cause the processor to:
determine a time interval between the preset time point and the target time point;
obtain a time attenuation factor of the abnormal event by using a first preset function to calculate a preset attenuation coefficient and the time interval;
determine the time attenuation weight of the abnormal event according to the occurrence frequency and the time attenuation factor.

18. The electronic device as recited in claim 11, wherein the plurality of instructions are further configured to cause the processor to:
convert the performance indicator data into a query vector using the self-attention mechanism, and convert the historical indicator data into a key vector using the self-attention mechanism;
determine the attention weight according to the query vector, the key vector, the correlation weights and the time attenuation weight.

19. The electronic device as recited in claim 11, wherein the performance evaluation data comprises precision data and recall data,
wherein the plurality of instructions are further configured to cause the processor to:
determine a harmonic mean of the expert model according to the precision data and the recall data;
determine a target value according to the first preset value and the harmonic mean;
obtain the convergence indicator by using a second preset function to calculate a second preset value and the target value.

20. The electronic device as recited in claim 19, wherein the second preset function is a sigmoid function.
